(19) United States
(12) Patent Application Publication
(10) Pub. No.: US 2016/0147937 A1
(43) Pub. Date: May 26, 2016

(54) APPARATUS AND METHOD FOR COUNTING ALLELES

(71) Applicant: ELECTRONICS AND TELECOMMUNICATIONS RESEARCH INSTITUTE, Daejeon (KR)

(72) Inventors: Dae-Hee KIM, Daejeon (KR); Min-Ho KIM, Daejeon (KR); Ho-Youl JUNG, Daejeon (KR); Young-Won KIM, Daejeon (KR); Myung-Eun LIM, Daejeon (KR); Jae-Hun CHOI, Daejeon (KR); Young-Woong HAN, Daejeon (KR)

(21) Appl. No.: 14/937,342

(22) Filed: Nov. 10, 2015

(30) Foreign Application Priority Data
Nov. 25, 2014 (KR) 10-2014-0165377
May 13, 2015 (KR) 10-2015-0066585

(51) Int. Cl. G06F 19/22

(52) U.S. Cl. CPC G06F 19/22

(57) ABSTRACT

An apparatus and method for counting alleles are disclosed herein. The apparatus for counting alleles includes a file input unit and a counting unit. The file input unit receives one or more files including human genome data. The counting unit reads the files on a predetermined window size basis by means of parallel reading using multi-threading based on the position information of the files, performs allele counting, and merges the results of the counting.

### CROSS-REFERENCE TO RELATED APPLICATIONS

This application claims the benefit of Korean Patent Application Nos. 10-2014-0165377 and 10-2015-0066585, filed Nov. 25, 2014 and May 13, 2015, respectively, which are hereby incorporated by reference herein in their entirety.

### BACKGROUND

1. Technical Field

The present invention relates generally to an apparatus and method for counting alleles and, more particularly, to an apparatus and method for receiving aligned binary alignment map (BAM) files, i.e., human genome data, and outputting the counting values of alleles (A, T, G, and C) for each position.

2. Description of the Related Art

The human genome composed of adenines (A), cytosines (C), thymines (T), guanines (G), and unclear bases (N) consists of about 3 billion bases.

When next-generation sequencing equipment is used to interpret such a massive human DNA, results having various sizes ranging from 30 GB to 200 GB are output in the form of BAM files depending on the multiple at which human DNA has been interpreted in the case of a single person.

When such BAM data is aligned at positions, it can be seen that a plurality of bases are aligned at each position. The characteristics of each position can be determined by checking the numbers of A, C, T and G placed at the position.

BAM data is used in various fields of application through single nucleotide polymorphism (SNP) and the comparison between a normal cell and a cancer cell.

Meanwhile, human genome data amounts up to 200 GB, and a significant time is required for input and output because about 1000 files should be simultaneously processed as input for the comparison between a normal cell and a cancer cell and between a plurality of persons. In particular, a significantly long time is required because BAM files used as input are compressed binary data.

Korean Patent No. 1008828 entitled “Multiplex PCR System Comprising 16 STR Loci and Amelogenin Which Are Highly Discriminative in Korean Population and Method of Human Identification Using Them” discloses a technology related to the present invention.

### SUMMARY

At least some embodiments of the present invention are directed to the provision of an apparatus and method for extracting allele counting values, i.e., the most important and basic data of human genome information, at high speed.

For this purpose, high-speed allele counting and the fast writing of files are enabled through parallel processing using the multi-threading of graphics processing units (GPU) and a central processing unit (CPU).

In accordance with an aspect of the present invention, there is provided an apparatus for counting alleles, including: a file input unit configured to receive one or more files including human genome data; and a counting unit configured to read the files on a predetermined window size basis by means of parallel reading using multi-threading based on the position information of the files, to perform allele counting, and to merge the results of the counting.

The files may be binary alignment map (BAM) files.

The counting unit may merge the results of the counting using a graphics processing unit (GPU)-based parallel processing scheme.

When merging the results, the counting unit may write data to be output to a GPU memory position predetermined for each thread, may store the number of required bytes, may calculate a prefix sum value using the byte value required for each thread, may calculate the start locations of respective threads in parallel using the prefix sum value, and may realign initially generated data using the prefix sum value and data length information processed for each position.

The counting unit may count the numbers of adenines (A), thymines (T), guanines (G), and cytosines (C) for each position of the files.

The counting unit may further count the numbers of unclear bases (N) and deletion chromosomes (D).

The apparatus may further include a storage unit configured to store the results output by the counting unit.

In accordance with an aspect of the present invention, there is provided a method of counting alleles, including: receiving, by an apparatus for counting alleles, one or more files including human genome data; and counting, by the apparatus for counting alleles, numbers of alleles based on the files; wherein counting the numbers of alleles including reading the files on a predetermined window size basis by means of parallel reading using multi-threading based on information position of the files; counting the numbers of alleles for the predetermined window size; and merging results of the counting.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of an apparatus for counting alleles according to an embodiment of the present invention;

FIG. 2 is a diagram illustrating the concept of the processing of a BAM file for each window;

FIG. 3 is a diagram illustrating the meaning of allele counting;

FIG. 4 is a diagram illustrating the output form of a single BAM file;

FIG. 5 is a flowchart illustrating a method for counting alleles according to an embodiment of the present invention;

FIG. 6 is a diagram showing a pile-up parallel execution method adopted in the description of FIG. 5;

FIG. 7 is a diagram illustrating the concept of merging adopted in the description of FIG. 5;

FIG. 8 is a diagram showing an example of output and the numbers of required bytes when the number of BAM files adopted in the description of FIG. 5 is two;

FIG. 9 is a flowchart illustrating a parallel merging method using GPUs adopted in the description of FIG. 5;

FIG. 10 is a diagram showing memory allocation for output adopted in the description of FIG. 5;

FIG. 11 is a diagram showing the realignment state of data adopted in the description of FIG. 5; and

FIG. 12 is a diagram showing a computer system in which an embodiment of the present invention has been implemented.

### DETAILED DESCRIPTION

The present invention may be subjected to various modifications and have various embodiments. Specific embodiments are illustrated in the drawings and described in detail below.

However, it should be understood that the present invention is not intended to be limited to these specific embodiments but is intended to encompass all modifications, equivalents and substitutions that fall within the technical spirit and scope of the present invention.

The terms used herein are used merely to describe embodiments, and not to limit the inventive concept. A singular form may include a plural form, unless otherwise defined. The terms, including “comprise,” “includes,” “comprising,” “including” and their derivatives specify the presence of described shapes, numbers, steps, operations, elements, parts, and/or groups thereof, and do not exclude presence or addition of at least one other shapes, numbers, steps, operations, elements, parts, and/or groups thereof.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Embodiments of the present invention are described in greater detail below with reference to the accompanying drawings. In order to facilitate the general understanding of the present invention, like reference numerals are assigned to like components throughout the drawings and redundant descriptions of the like components are omitted.

In an embodiment of the present invention, to achieve fast high-speed processing, a multi-threading task using OpenMp is used in an input part. In particular, a file generation device part guarantees fast execution speed by means of a parallel write method using graphics processing units (GPU).

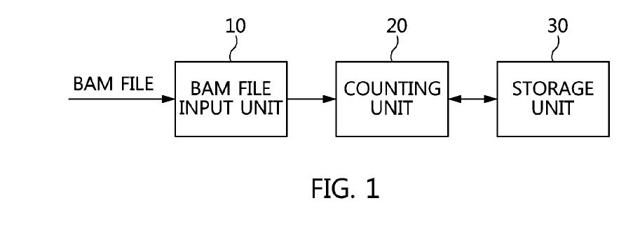

FIG. 1 is a diagram showing the configuration of an apparatus for counting alleles according to an embodiment of the present invention.

The apparatus for counting alleles according to the present embodiment includes a BAM file input unit 10, a counting unit 20, and a storage unit 30.

The BAM file input unit 10 receives a massive size aligned binary alignment map (BAM) file including human genome data. In this case, although the BAM file input unit 10 is described as receiving a BAM file, a file that is received by the BAM file input unit 10 is not limited to the BAM file. For example, any file including human genome data, other than a BAM file, may be received.

The counting unit 20 outputs values (i.e., allele counting values) obtained by counting the numbers of alleles (A, T, G, C, N, and D), i.e., the most basic data of human genome information, based on the massive size BAM file input to the BAM file input unit 10.

The storage unit 30 may store the results, i.e., the allele counting values, output by the counting unit 20.

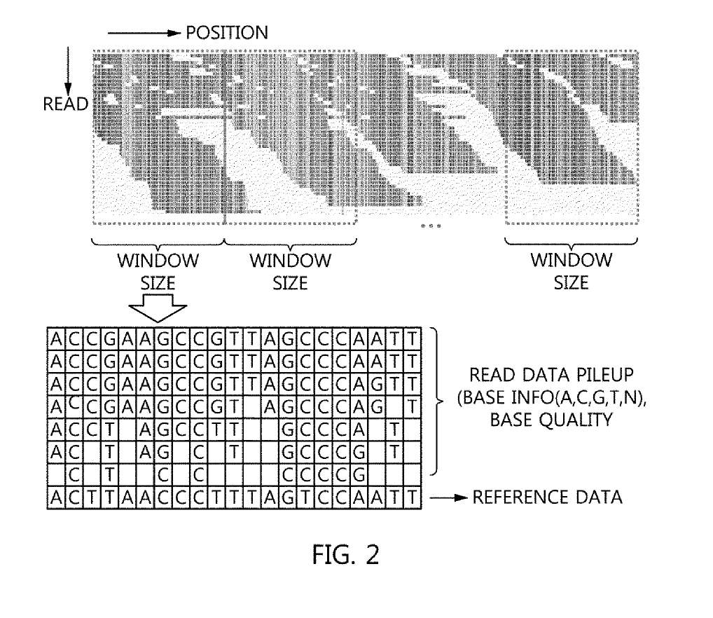

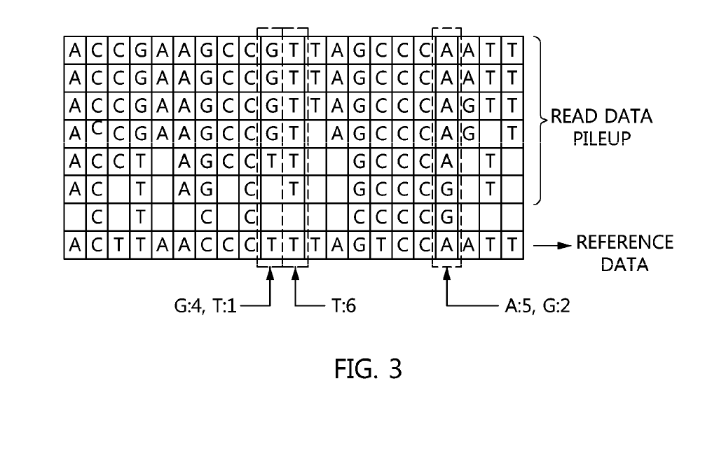

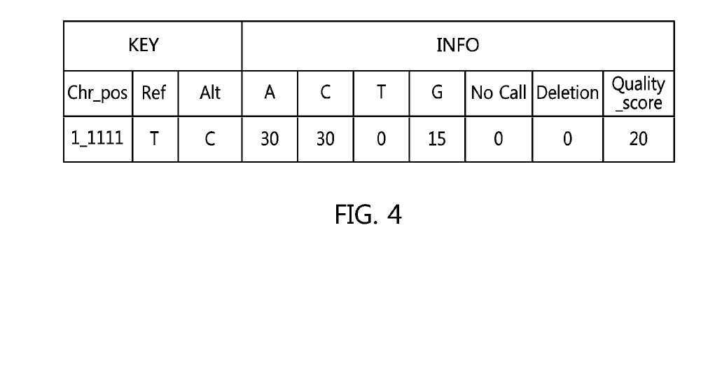

FIG. 2 is a diagram illustrating the concept of the processing of a BAM file for each window, FIG. 3 is a diagram illustrating the meaning of allele counting, and FIG. 4 is a diagram illustrating the output form of a single BAM file.

FIG. 2 shows a BAM file at individual positions. When specific position A is enlarged, bases appear. A reference is a reference base sequence. Aligned READs (i.e., short scrap sequence pieces generated by next-generation sequencing equipment) are placed at individual positions, and the number of positions is 3 billion. Accordingly, since it is impossible to read a file to main memory (memory) at one time, a window size is set up and then each section is processed at one time. That is, although the BAM file input unit 10 may receive an overall BAM file at one time, each section corresponding to the set-up window size is received at one time because the size of the BAM file is massive.

The counting unit 20 counts and outputs the numbers of adenines (A), cytosines (C), thymines (T), guanines (G), no calls (N), unclear bases, and deletions (D) (deletion chromosomes), as illustrated in FIG. 3, with respect to the bases received from the BAM file input unit 10. In the case of a single BAM file, the form of an output file (i.e., data) has a form, such as that shown in FIG. 4. Furthermore, the output file (i.e., data) is stored in the storage unit 30.

Data in a text form is generated with respect to a single position, as shown in FIG. 4. In the case of a plurality of BAM files, the amount of information Info further increases.

In “1_1111” of FIG. 4, “1” denotes the name of “chr”, i.e., a No. 1 chromosome, and “1111” denotes a position. Furthermore, “T” subsequent to “1111” is a reference base, and, in the example of FIG. 4, means the reference of the position 111 of the No. 1 chromosome. If “Alt” subsequent to “T” is the same as the reference, it is indicated by “-.” If “Alt” is different from the reference, it is indicated by a symbol, e.g., C in the example of FIG. 4. A, C, T, G, N, D, and a quality value follow “Alt.”

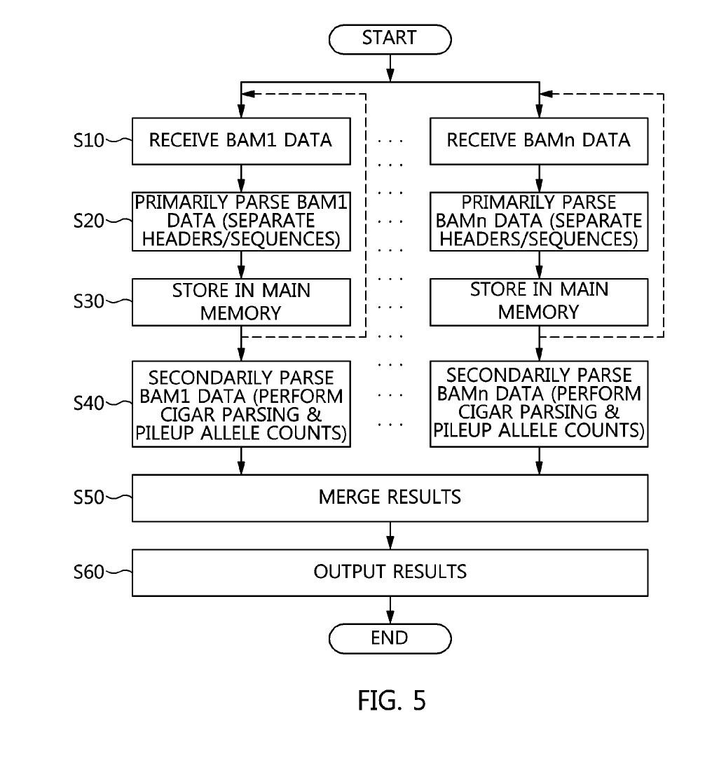

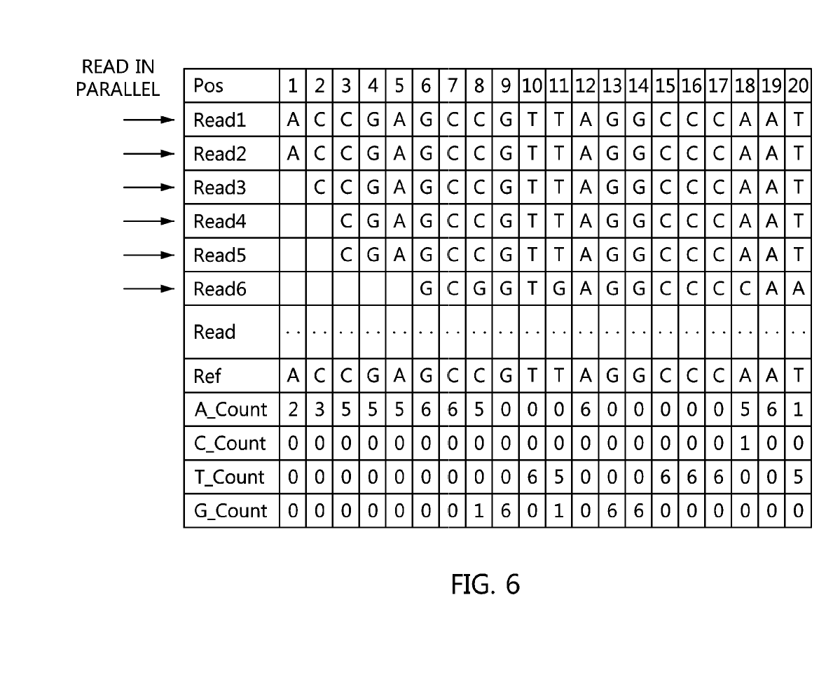

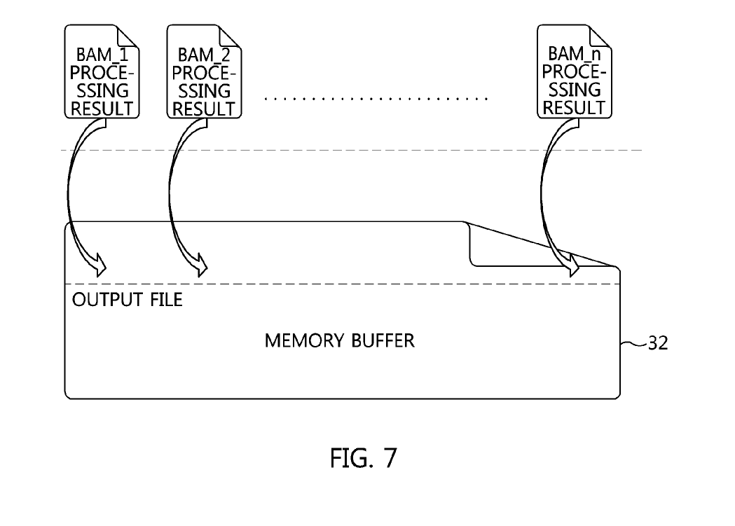

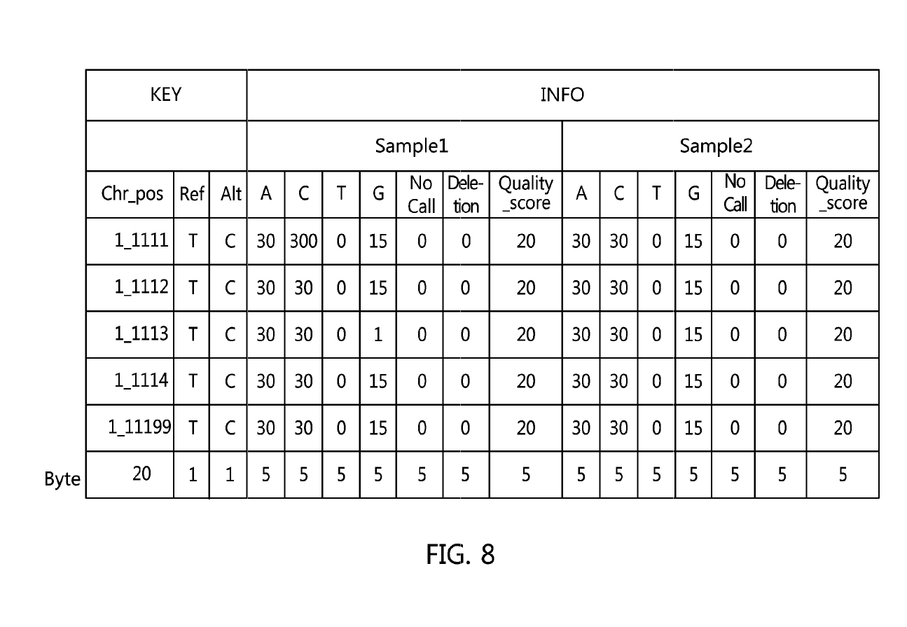

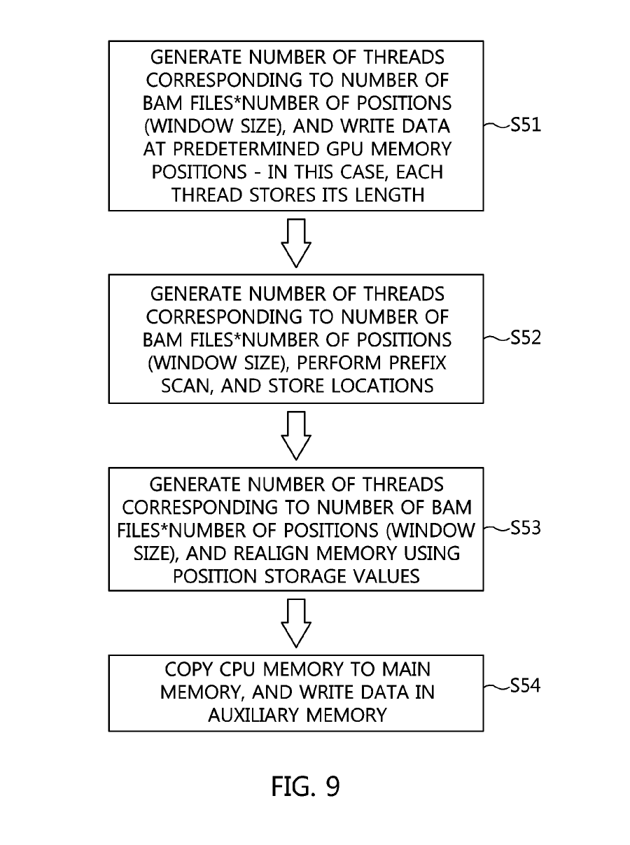

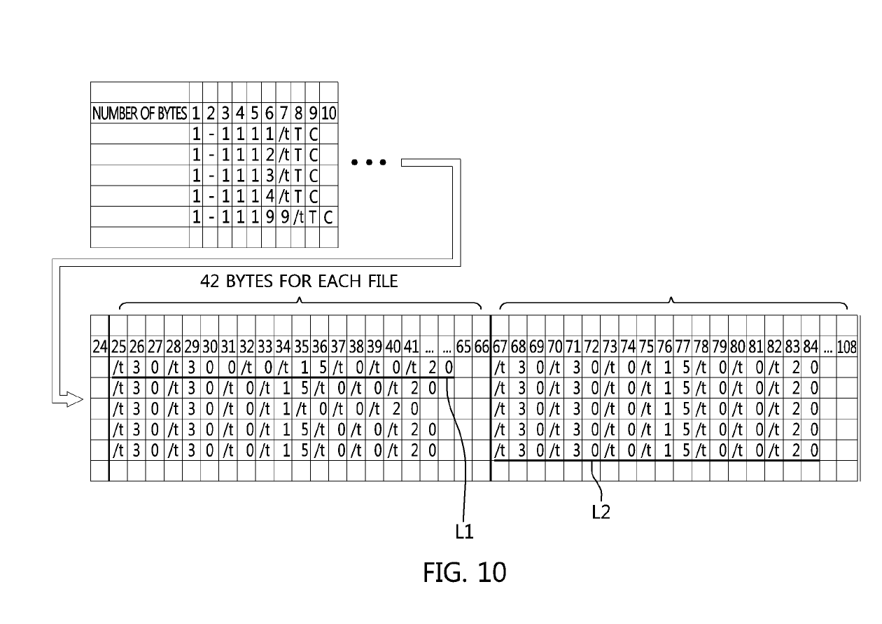

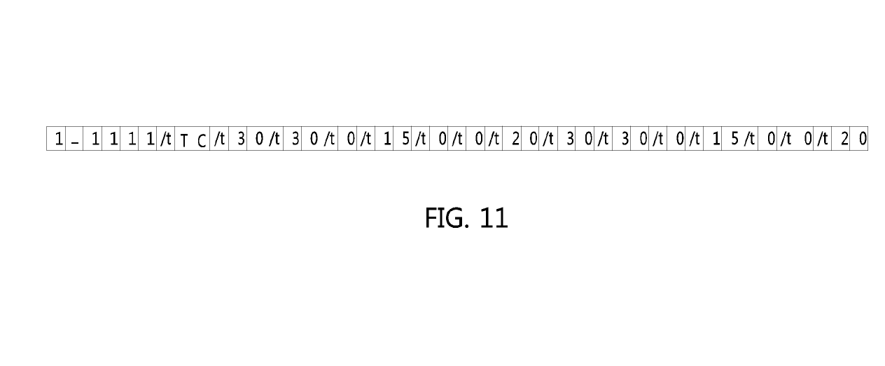

A method for counting alleles according to an embodiment of the present invention is described below with reference to the flowchart of FIG. 5. FIG. 6 is a diagram showing a pile-up parallel execution method adopted in the description of FIG. 5, FIG. 7 is a diagram illustrating the concept of merging adopted in the description of FIG. 5, FIG. 8 is a diagram showing an example of output and the numbers of required bytes when the number of BAM files adopted in the description of FIG. 5 is two, FIG. 9 is a flowchart illustrating a parallel merging method using GPUs adopted in the description of FIG. 5, FIG. 10 is a diagram showing memory allocation for output adopted in the description of FIG. 5, and FIG. 11 is a diagram showing the realignment state of data adopted in the description of FIG. 5.

First, the BAM file input unit 10 receives BAM files BAM1, . . . , BAMn, i.e., the compressed data of binary files, at step S10.

Thereafter, the counting unit 20 separates headers and sequences from the BAM files BAM1, . . . , BAMn by primarily parsing the BAM files BAM1, . . . , BAMn at step S20. In this case, each of the BAM files stores sequence data. Furthermore, the header of the BAM file includes all the reference sequence names and their lengths.

Furthermore, the counting unit 20 reads READ data and stores an amount of READ data corresponding to a window size in main memory at step S30. In this case, although the main memory (e.g., a memory buffer) is not illustrated as being separate, main memory 32 may be configured to be separate from the counting unit 20, or may be included in the counting unit 20. Furthermore, the main memory may be configured to have a capacity of about 20 GB or more.

Thereafter, the counting unit 20 secondarily parses the stored READ data using CIGAR information at step S40. The READ data that is now being processed can be determined by secondarily parsing the stored READ data. When the READ data is read through the secondary parsing, the counting unit 20 uses a parallel reading method using multi-threading. The parallel reading method may be the same as that of FIG. 6.

As shown in FIG. 6, if CIGAR parsing (i.e., secondary parsing) is performed in parallel within a single window, the bases (i.e., A, C, T, and G) of the READ data are sequentially extracted. The counting unit 20 immediately counts the extracted data. In this case, N (unclear bases) and D (deletion chromosomes) may be extracted together, and the numbers of extracted N and D may be counted. Meanwhile, since CIGAR parsing is processed in parallel as described above, the simultaneous performance of write tasks at a single position is prohibited (which corresponds to the concept of a critical section or locking). Accordingly, the counting unit 20 performs processing using “atomic” in OpenMp.

As described above, the counting unit 20 reads an amount of data of each of the BAM files BAM1, . . . , BAMn corresponding to the window size at the same positions based on the position information of the BAM files BAM1, . . . , BAMn (e.g., it means that when a window size is 30000, data of each the BAM files at positions ranging from 0 to 30000 is read with respect to the first window; a second window ranges from 30001 to 60000). After counting the alleles of the data, the counting unit 20 merges the results at step S50.

In general, such merging is a task that includes many outputs and thus requires a heavy load. In order to solve this problem, high-speed merging scheme using GPUs is adopted. In a method for high-speed merging, the memory buffer (i.e., main memory) (32 in FIG. 7) capable of handling a window size to be used for output is prepared. The memory buffer 32 is finally completed using a parallel processing scheme (e.g., a GPU-based parallel processing scheme). The data is written in an auxiliary memory device (e.g., a hard disk) at one time, and results are output. In this case, the auxiliary memory device may also be considered to be the storage unit 30. When the memory buffer is filled with data, a part performed by the GPUs is important. For this, the following method is used.

Referring to FIG. 4, the lengths of the chromosome number_position “chr_pos” and the results of counting (i.e., the values of A, C, T, G, N, and D within Info) are different from each other. In order to provide sufficient memory, 5 bytes are allocated to the result of counting indicated by one or more numerals. The maximum value of READ counting can cover up to 99999 because 5 bytes have been allocated. In general cases, 10000 is not exceeded for an actual single position. In order to process a counting value exceeding 99999, a strategy in which a corresponding position is skipped is used.

The following description is given using an embodiment. As shown in FIG. 8, 20 bytes are allocated to the chromosome number_position “chr_pos” because the chromosome number_position “chr_pos” does not exceed a maximum of 20 characters, 1 byte is allocated to each of Ref and Alt, and 5 bytes are allocated to each of A, C, T, G, N, and D. Furthermore, 1 byte is allocated to a delimiter (e.g., “/t”) because the delimiter is inserted between two pieces of data. Accordingly, a total of 24 bytes are allocated to chr_pos, Ref, and Alt. 6(5+1) bytes*7 (A, C, T, G, N, D, Q)=42 bytes are allocated to Info in each BAM file. For example, assuming that the number of BAM files is 1000 and a position size (i.e., a window size) is 30 thousands, (24+42*1000)*30000 bytes are allocated.

The memory allocated as described above is allocated for both the main memory and the GPUs. In particular, a single piece of the memory is further allocated for the GPUs in order to support memory realignment. The counting unit 20 performs a merging task using the main memory and the GPUs, and a process for the merging task is illustrated in FIG. 9. In this case, the main memory and the GPUs may be understood as being included in the counting unit 20.

In FIG. 9, when parallel merging is performed using GPUs, GPU kernels are sequentially activated a total of three times. Each of the GPU kernels processes a number of threads corresponding to the number of BAM files*the number of positions (i.e., a window size) (i.e., 30000*1000 if the window size is 30000 and the number of BAM files is 1000).

A first GPU kernel writes data (e.g., data in a form including a Chr name, the locations of a position, and the counting values of A, C, T, G, N and D, such as “13_26583801 G - 0 0 0 3 0 0 24”; see FIG. 4) to be output to a predetermined GPU memory position in each thread. The illustrated “13_26583801 G - 0 0 0 3 0 0 24” indicates that the number of G was 3 in a base at the 26583801st position of a No. 13 chromosome as a result of DNA amplification and analysis, the accuracy of quality was about 24, and the reference of a corresponding location was G. In this case, the length of data actually generated in a thread processed by itself is also stored in parallel at step S51. This is described below with reference to FIG. 10. If a thread in question is a thread that processes a specific file part at a specific position, the locations of the thread on the memory may be previously known (because a memory size has been previously allocated as described above), and data is written at the locations. The data is placed on GPU memory as shown in FIG. 10 in accordance with the example of FIG. 8.

As seen from FIG. 10, empty spaces occur in an overall area due to parallel processing (because memory having a size larger than the size of actual data has been allocated). In order to remove these empty portions, a start location should be known for each position of each file. In order to calculate the start location, the number of bytes required for a portion that is being processed is stored while the first GPU kernel is being run (i.e., data is being written in a GPU memory buffer). For example, in FIG. 10, a value of 19 is stored as the number of bytes required for the first BAM file at a window 1111st position, as in a portion indicated by line L1. In FIG. 10, a value of 18 is stored in the case of the second BAM file at a window 11199th position, as in a portion indicated by line L2.

A second GPU kernel calculates start locations at step S52. The second GPU kernel may calculate a prefix sum value using the calculated byte values required for respective threads, and may calculate the start locations of the respective threads in parallel using the prefix sum.

A third GPU kernel realigns initially generated data (such as that of FIG. 10) on the memory using the calculated prefix sum value and data length information processed for the individual positions, as shown in FIG. 11, at step S53. Using this, the empty spaces are removed. After the empty spaces have been removed as described above, single piece of final data in a lengthy one-dimensional array form is completed.

The data generated as described above is moved to the main memory and immediately written to the storage unit 30 (e.g., an auxiliary memory device) at step S54.

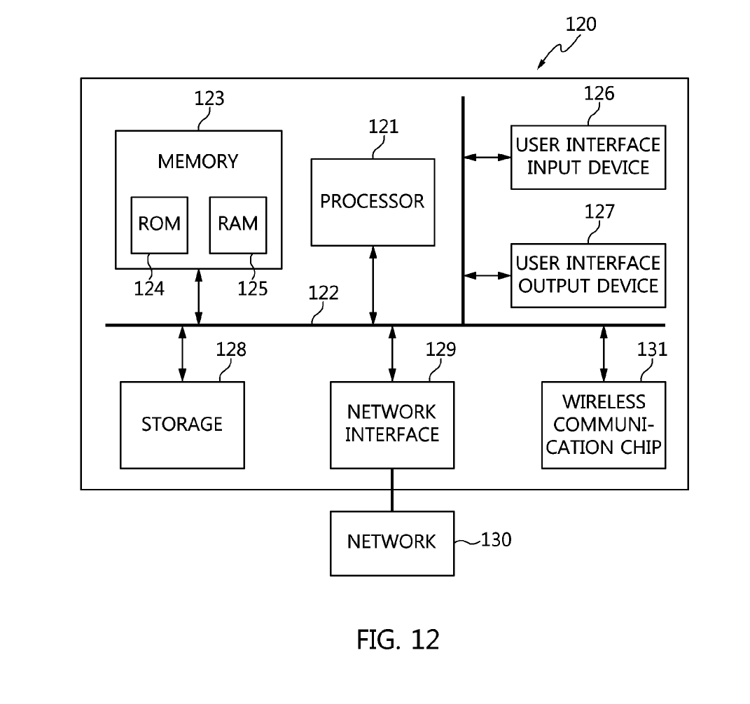

The above-described embodiment of the present invention may be implemented in a computer system. As shown in FIG. 12, the computer system 120 may include at least one processor 121, at least one piece of memory 123, at least one user interface input devices 126, at least one user interface output device 127, and at least one piece of storage 128, which are configured to communicate with each other via a bus 122. The computer system 120 may further include at least one network interface 129 connected to a network 130. The processor 121 may be a CPU, or a semiconductor device configured to execute processing instructions stored in the memory 123 or storage 128. The memory 123 and the storage 128 may be a variety of types of volatile or non-volatile storage media. For example, the memory 123 may include read-only memory (ROM) 124 or random-access memory (RAM) 125.

Furthermore, in the case where the computer system 120 has been implemented as a small-sized computing device in preparation for the IoT era, when an Ethernet cable is connected to the computing device, the computing device may operate like a wireless sharer, and thus a mobile device may wirelessly access a gateway and perform an encryption and decryption function. For this purpose, the computer system 120 may further include a wireless communication chip (a Wi-Fi chip) 131.

Accordingly, at least one embodiment of the present invention may be implemented using a non-transient computer-readable storage medium having a computer-implemented method or computer-executable instructions stored therein. When the computer-executable instructions are executed by a processor, the computer-executable instructions may perform a method according to at least one embodiment of the present invention.

In accordance with an embodiment of the present invention, allele counting values, i.e., the most basic data of human genome information, can be extracted at high speed.

In particular, alleles are counted in parallel while BAM files are being parsed. Meanwhile, integrated result data at a specific position is required to compare a cancer cell with a normal cell. For this purpose, three kernels are sequentially activated using GPUs and a high-speed merging method based on a parallel processing scheme using tens of millions of threads is used. Accordingly, fast processing speed can be expected.

As described above, the exemplary embodiments have been disclosed in the drawings and the specification. Although the specific terms have been used herein, they have been used merely for the purpose of describing the present invention, but have not been used to restrict their meanings or limit the scope of the present invention set forth in the claims. Accordingly, it will be understood by those having ordinary knowledge in the relevant technical field that various modifications and other equivalent embodiments can be made. Therefore, the true range of protection of the present invention should be defined based on the technical spirit of the attached claims.

What is claimed is:

1. An apparatus for counting alleles, comprising:
a file input unit configured to receive one or more files including human genome data; and
a counting unit configured to read the files on a predetermined window size basis by means of parallel reading using multi-threading based on position information of the files, to perform allele counting, and to merge results of the counting.

2. The apparatus of claim 1, wherein the files are binary alignment map (BAM) files.

3. The apparatus of claim 1, wherein the counting unit merges the results of the counting using a graphics processing unit (GPU)-based parallel processing scheme.

4. The apparatus of claim 3, wherein the counting unit, when merging the results, writes data to be output to a GPU memory position predetermined for each thread, stores a number of required bytes, calculates a prefix sum value using the byte value required for each thread, calculates start locations of respective threads in parallel using the prefix sum value, and realigns initially generated data using the prefix sum value and data length information processed for each position.

5. The apparatus of claim 1, wherein the counting unit counts numbers of adenines (A), thymines (T), guanines (G), and cytosines (C) for each position of the files.

6. The apparatus of claim 5, wherein the counting unit further counts numbers of unclear bases (N) and deletion chromosomes (D).

7. The apparatus of claim 1, further comprising a storage unit configured to store the results output by the counting unit.

8. A method of counting alleles, comprising:
receiving, by an apparatus for counting alleles, one or more files including human genome data; and
counting, by the apparatus for counting alleles, numbers of alleles based on the files;
wherein counting the numbers of alleles comprises:
reading the files on a predetermined window size basis by means of parallel reading using multi-threading based on information position of the files;
counting the numbers of alleles for the predetermined window size; and
merging results of the counting.

9. The method of claim 8, wherein the files are BAM files.

10. The method of claim 8, wherein merging the results of the counting comprises merging the results of the counting using a GPU-based parallel processing scheme.

11. The method of claim 10, wherein merging the results of the counting comprises:
writing data to be output to a GPU memory position predetermined for each thread, and storing a number of required bytes;
calculating a prefix sum value using the byte value required for each thread;
calculating start locations of respective threads in parallel using the prefix sum value; and
realigns initially generated data using the prefix sum value and data length information processed for each position.

12. The method of claim 8, wherein counting the numbers of alleles comprises counting numbers of adenines (A), thymines (T), guanines (G), and cytosines (C) for each position of the file.

13. The method of claim 12, wherein counting the numbers of alleles comprises further counting numbers of unclear bases (N) and deletion chromosomes (D).
